(19) United States
(12) Patent Application Publication
(10) Pub. No.: US 2007/0144406 A1
(43) Pub. Date: Jun. 28, 2007

(54) Shrinkage Reducing Additive for Cement Compositions

(75) Inventor: Davide Zampini, Orpun (CH)

Correspondence Address: CURATOLO SIDOTI CO., LPA, 24500 CENTER RIDGE ROAD, SUITE 280, CLEVELAND, OH, 44145, US

(73) Assignee: CONSTRUCTION RESEARCH & TECHNOLOGY GMBH, Trostberg (DE)

(21) Appl. No.: 10/551,333

(22) PCT Filed: Mar. 3, 2004
(86) PCT No.: PCT/EP04/02099

§ 371 Date: Jan. 24, 2007

(30) Foreign Application Priority Data
Apr. 7, 2003 (GB) 0307920.9

(51) Int. Cl. C04B 24/00; C04B 40/00

(52) U.S. Cl. 106/806; 106/724; 106/823

(57) ABSTRACT

A method of reducing the drying shrinkage of a cementitious composition to which water has been added and the composition placed, comprising adding to the composition prior to placement at least one siloxane compound that is at least one of liquid and soluble in at least one of water and aqueous alkali.

This invention relates to the prevention of shrinkage in cementitious compositions and to materials for achieving this.

A commonly-encountered problem with cementitious compositions such as concrete and mortar is their tendency to shrink on drying after placement. This can cause some cracking, the presence of which can not only be unsightly but which also can allow the penetration of water into the cementitious composition. This can degrade the concrete by, for example, freezing and thawing in winter conditions, or by allowing water and/or aggressive chemicals to reach steel reinforcing embedded in the concrete, causing corrosion and reducing durability.

The subject has been intensively studied and a large patent literature is evidence of the commonness of the problem and the desirability of solving it.

It has now been found that a particular class of materials can reduce substantially the drying shrinkage of cementitious compositions. The invention therefore provides a method of reducing the drying shrinkage of a cementitious composition to which water has been added and the composition placed, comprising adding to the composition prior to placement at least one siloxane compound that is at least one of liquid and soluble in at least one of water and aqueous alkali.

By “siloxane compound” is meant any siloxane-based material, that is, a material having a linear or branched siloxane backbone chain of the form —SiR^{a}R^{b}—O—SiR^{c}R^{d}—O—. Any such material will work in this invention, provided that it is liquid or at least slightly soluble in at least one of water and aqueous alkali.

Preferred siloxane compounds for use in this invention are selected from those that correspond to the general formula I:

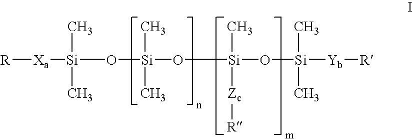

where m and n are independently from 1-2000, preferably from 1-500 and more preferably from 1-200, a, b, and c are independently either 0 or 1 and X Y and Z are selected from
—O—;
—O—(CH₂)₁₋₃₀—, this moiety being at least one of linear, branched and containing at least one ring;
—(CH₂)₁₋₃₀—, this moiety being at least one of linear, branched and containing at least one ring;
—CH₂—CH₂—CH₂—O—;
—CH₂—CH₂—CH₂—O—CH₂—CHOH—CH₂—;
—CH₂—CH₂—CH₂—O—CH₂—CHOH—CH₂—O—;
—CH₂—CH₂—CH₂—O—CH₂—CHOH—CH₂—N—;

and R, R′ and R″ are independently selected from at least one of hydrogen, C₁₋₁₀₀ alkyl, C₆₋₃₀ aryl, C₇₋₃₀ aralkyl; C₇₋₃₀ alkaryl; C₁₋₃₀ hydroxyalkyl; C₃₋₂₀₀ polyhydroxyalkyl; polyether consisting of from 2-200 identical or different C₁₋₁₅ oxyalkylene units, with the proviso that, if there is present more than one type of oxyalkylene unit, there shall be present at least two of each unit; C₁₋₃₀ aminoalkyl; polyiminopolyalkylene having from 1-20 identical or different C₂₋₁₅ alkylene units; polyiminopolyoxyalkylene having from 1-20 identical or different C₂₋₁₅ oxyalkylene units; C₃₋₃₀ quaternary ammonium, optionally completely or partially ionised with at least one anion; C₄₋₃₀ betaine; carboxyl, optionally completely or partially ionised with any suitable cation; C₄₋₃₀ polycarboxyalkyl, optionally completely or partially ionised with at least one cation; sulpho group, optionally completely or partially ionised with at least one cation; thiosulpho group, optionally completely or partially ionised with at least one cation; epoxide group; glycidyl; acrylate; C₁₋₃₀ ester; polyester consisting of from 2-200 C₂₋₁₅ diacid and diester monomer units; and esters of inorganic acids, all alkyl chains being at least one of linear, branched and comprising at least one ring.

A more preferred class of siloxane compounds comprises those of Formula I in which a, b, and c are all 1 and X, Y and Z are selected from
—O—(CH₂)₁₋₃₀—, this moiety being linear or branched;
—(CH₂)₁₋₃₀—, this moiety being linear or branched;
—CH₂—CH₂—CH₂—O—CH₂—CHOH—CH₂—;

and R, R′ and R″ are independently selected from at least one of hydrogen; hydroxy; polyether consisting of from 2-200 identical or different C₂₋₆ oxyalkylene units, with the proviso that, if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; sulpho group, optionally completely or partially ionised with at least one cation; thiosulpho group, optionally completely or partially ionised with at least one cation; glycidyl; and acrylate; all alkyl chains being at least one of linear, branched and comprising at least one ring.

An even more preferred class of siloxane compounds comprises those of Formula I in which m and n are independently selected from 1-200, a, b, and c are all 1 and X, Y and Z are selected from
—O—(CH₂)₁₋₁₂—;
—(CH₂)₁₋₁₂—;
—CH₂—CH₂—CH₂—O—CH₂—CHOH—CH₂—;

and R, R′ and R″ are independently selected from at least one of hydrogen; hydroxy, polyether consisting of from 2-200 identical or different C₂₋₆ oxyalkylene units, with the proviso that, if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; glycidyl; and acrylate; all allyl chains being capable of being linear or branched.

An even more preferred class of siloxane compounds comprises those of Formula I in which m is from 1-30 and n is from 1-100, a, b, and c are all 1 and X, Y and Z are selected from
—O—(CH₂)₁₋₆—;
—(CH₂)₁₋₆—;
—CH₂—CH₂—CH₂—O—CH₂—CHOH—CH₂—;

and R, R′ and R″ are independently selected from at least one of hydrogen; hydroxy; polyether consisting of from 2-200 identical or different C₂₋₆ oxyalkylene units, with the proviso that, if there is present more than one type of oxyalkylene unit, there shall be present at least two of each unit; C₃₋₂₀ quaternary ammonium, optionally completely or partially ionised with at least one anion; C₄₋₁₀ betaine and carboxyl, optionally completely or partially ionised with at least one cation; all alkyl chains being capable of being linear or branched.

The siloxanes hereinabove described may be any such material known to the art. Such materials are well known to the art for a variety of purposes, one of these being as antifoams in various industries. The preferred materials are those where R and R′ are methyl or ethyl, n is from 5-200, more preferably from 10-150 and most preferably from 40-100, and m is from 1-100, more preferably from 2-40 and most preferably from 5-10.

The two different types of siloxane units may be arranged randomly or in blocks on the molecule. It is possible to utilise more than one type of moiety R″. Examples of R″ include ethylene oxide—propylene oxide copolymers of from 10 to 100 units.

The siloxanes that are useful in the present invention may either be incorporated into a dry cementitious composition, or they may be added to such a composition when it is mixed with water immediately prior to placement. The quantity required depends on the type of cement and the precise nature of the siloxane, but a typical range of weight proportions is from 0.05%-20% by weight of the weight of the cement, more preferably from 0.1-5%, even more preferably from 0.1-2% and most preferably from 0.2-1%.

In a further embodiment of the invention, the siloxane may be used in conjunction with hydrophobic, finely-divided silica. This can be added to the composition separately from the siloxane, but it is preferred that it be incorporated into the siloxane by, for example, is blending or mixing. The quantity of silica can be up to 20% by weight of the siloxane, preferably no more than 10%. In a yet further embodiment of the invention, the siloxane may additionally contain emulsifier. Any suitable emulsifiers may be used in art-recognised quantities. Some commercially-available emulsifiers already contain emulsifier, so addition may be unnecessary.

In addition to the siloxane hereinabove described, there can also be added to the cementitious mix materials known to the art for the performance of particular functions, in art-recognised quantities. Such materials include (but are not limited to) plasticisers and superplasticisers, antifreeze agents, pigments, air-entraining agents, accelerators, retarders and reinforcing fibres of metal, glass or polymer.

Cementitious mixes to which the siloxanes as hereinabove described have been added exhibit superior shrinkage characteristics, leading to better aesthetic appearance, reduced permeability and superior properties with respect to durability. The invention therefore also provides a cementitious composition which includes a siloxane as hereinabove described.

The invention is further described with reference to the following non-limiting example.

A polyether siloxane (“Tego” (trade mark) 2008 MR ex Degussa AG is used) is added to a concrete mix of the following composition:

| | |
|---|---|
| Portland cement | 450 parts by weight |
| Aggregate | |
| 0-4 mm | 770 parts by weight |
| 4-8 mm | 440 parts by weight |
| 8-16 mm | 440 parts by weight |

W/C ratio 0.47

This mix is subjected to the shrinkage test of German Industrial Standard DIN 52 450, along with a mix that does not contain the siloxane.

The results are as follows:

shrinkage (mm/M)

| Age(days) | with siloxane | without siloxane |
|---|---|---|
| 1 | 0 | 0 |
| 3 | −0.119 | 0.029 |
| 7 | −0.074 | 0.157 |
| 10 | −0.006 | 0.195 |
| 14 | 0.057 | 0.225 |
| 28 | 0.082 | 0.349 |
| 42 | 0.17 | 0.405 |
| 49 | 0.193 | 0.418 |
| 59 | 0.167 | 0.396 |
| 70 | 0.244 | 0.48 |
| 80 | 0.271 | 0.503 |

1. A method of reducing the drying shrinkage of a cementitious composition to which water has been added and the composition placed, comprising adding to the composition prior to placement at least one siloxane compound that is at least one of liquid or soluble in at least one of water or aqueous alkali.

2. The method according to claim 1, in which the siloxane compound is selected from those that correspond to the general formula I: 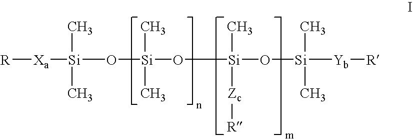
where m and n are independently from 1-2000, a, b, and c are independently either 0 or 1 and X, Y and Z are selected from
—O—;
—O—(CH₂)₁₋₃₀—, this moiety being at least one of linear, branched or containing at least one ring;
—(CH₂)₁₋₃₀—, this moiety being at least one of linear, branched or containing at least one ring;
—CH₂—CH₂—CH₂—O—;
—CH₂—CH₂—CH₂—O—CH₂—CHOH—CH₂—;
—CH₂—CH₂—CH₂—O—CH₂—CHOH—CH₂—O—; and
—CH₂—CH₂—CH₂—O—CH₂—CHOH—CH₂—N—;
and R, R′ and R″ are independently selected from at least one of hydrogen, C₁₋₁₀₀ alkyl, C₆₋₃₀ aryl, C₇₋₃₀ aralkyl; C₇₋₃₀ alkaryl; C₁₋₃₀ hydroxyalkyl; C₃₋₂₀₀ polyhydroxyalkyl; polyether consisting of from 2-200 identical or different C₁₋₁₅ oxyalkylene units, wherein, if there is present more than one type of oxyalkylene unit, there shall be present at least two of each unit; C ₁₋₃₀ aminoalkyl; polyiminopolyalkylene having from 1-20 identical or different C₂₋₁₅ alkylene units; polyiminopolyoxyalkylene having from 1-20 identical or different C₂₋₁₅ oxyalkylene units; C₃₋₃₀ quaternary ammonium, optionally completely or partially ionised with at least one anion; C₄₋₃₀ betaine; carboxyl, optionally completely or partially ionised with at least one cation; C₄₋₃₀ polycarboxyalkyl, optionally completely or partially ionised with at least one cation; sulpho group, optionally completely or partially ionised with at least one cation; thiosulpho group, optionally completely or partially ionised with at least one cation; epoxide group; glycidyl; acrylate; C₁₋₃₀ ester; polyester consisting of from 2-200 C₂₋₁₅ diacid and diester monomer units; and esters of inorganic acids, wherein all alkyl chains are at least one of linear, branched or comprising comprise at least one ring.

3. The method according to claim 2, wherein the siloxane compound of formula I is such that a, b, and c are all 1 and X, Y and Z are selected from
—O—(CH₂)₁₋₃₀, this moiety being linear or branched;
—(CH₂)₁₋₃₀, this moiety being linear or branched; and
—CH₂—CH₂—CH₂—O—CH₂—CHOH—CH₂—;
and R, R′ and R″ are independently at least one of hydrogen; hydroxy; polyether consisting of from 2-200 identical or different C₂₋₆ oxyalkylene units, wherein, if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; sulpho group, optionally completely or partially ionised with at least one cation; thiosulpho group, optionally completely or partially ionised with at least one cation;glycidyl; and acrylate; all alkyl chains being at least one of linear, branched or comprising at least one ring.

4. The method according to claim 2, in which the siloxane compound of Formula I is such that m and n are independently selected from 1-200, a, b, and c are all 1 and X, Y and Z are selected from
—O—(CH₂)₁₋₁₂—;
—(CH₂)₁₋₁₂—; and
—CH₂—CH₂—CH₂—O—CH₂—CHOH—CH₂—;
and R, R′ and R″ are independently selected from at least one of hydrogen; hydroxy; polyether consisting of from 2-200 identical or different C₂₋₆ oxyalkylene units, wherein, if there is present more than one type of oxyalkylene unit, there shall be present at least two of each unit; C₃₋₃₀ quaternary ammonium, optionally completely or partially ionised with at least one anion; C₄₋₃₀ betaine; carboxyl, optionally completely or partially ionised with at least one cation; glycidyl; and acrylate; wherein all alkyl chains may be linear or branched.

5. The method according to claim 2, in which the siloxane compound of Formula I is such that m is from 1-30 and n is from 1-100, a, b, and c are all 1 and X, Y and Z are selected from
—O—(CH₂)₁₋₆—;
—(CH₂)₁₋₆—; and
—CH₂—CH₂—CH₂—O—CH₂—CHOH—CH₂—;
and R, R′ and R″ are independently selected from at least one of hydrogen; hydroxy; polyether consisting of from 2-200 identical or different C₂₋₆ oxyalkylene units, wherein, if there is present more than one type of oxyalkylene unit, there shall be present at least two of each unit; C₃₋₂₀ quaternary ammonium, optionally completely or partially ionised with at least one anion; C₄₋₁₀ betaine and carboxyl, optionally completely or partially ionised with at least one cation; all alkyl chains may be linear or branched.

6. The method according to claim 1, in which finely-divided silica is added to the cementitious composition.

7. A cementitious composition with reduced drying shrinkage, prepared by the method according to claim 1.

8. The cementitious composition according to claim 7, in which the composition additionally contains finely-divided silica.

9. The method according to claim 2 wherein m and n are independently from 1 to 500.

10. The method according to claim 2 wherein m and n are independently from 1 to 200.

11. The method according to claim 2 wherein R and R′ are methyl or ethyl.

12. The method according to claim 2 wherein R″ comprises ethylene oxide—propylene oxide copolymers of from 10 to 100 units.

13. The method according to claim 2 wherein more than one type of R″ moiety is present in the siloxane compound of Formula I.

14. The method according to claim 1 wherein the siloxane compound is added to the cementitious composition by at least one of:
a. being incorporated into the cementitious composition before the addition of water; or
b. added to the cementitious composition when it is mixed with water prior to placement.

15. The method according to claim 1 wherein the amount of siloxane compound added to the cementitious composition is from 0.05% to 20% by weight of the cement.

16. The method according to claim 1 wherein finely-divided silica is added to the cementitious composition separately for the siloxane compound or it may be incorporated into the siloxane compound.

17. The method according to claim 1 wherein the amount of finely-divided silica added is up to 20% by weight of the siloxane.

18. The method according to claim 1 wherein an emulsifier is incorporated into the siloxane compound.

19. The method according to claim 1 wherein at least one of at least one of plasticizers, superplasticisers, antifreeze agents, pigments, air-entraining agents, accelerators, retarders or reinforcing fibres that are comprised of at least one of metal, glass or polymer is added to the cementitious composition.

20. The cementitious composition according to claim 7, in which the siloxane compound is selected from those that correspond to the general formula I: 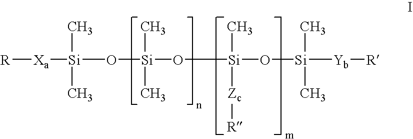
where m and n are independently from 1-2000, a, b, and c are independently either 0 or 1 and X, Y and Z are selected from
—O—;
—O—(CH₂)₁₋₃₀—, this moiety being at least one of linear, branched or containing at least one ring;
—(CH₂)₁₋₃₀—, this moiety being at least one of linear, branched or containing at least one ring;
—CH₂—CH₂—CH₂—O—;
—CH₂—CH₂—CH₂—O—CH₂—CHOH—CH₂—;
—CH₂—CH₂—CH₂—O—CH₂—CHOH—CH₂—O—; and
—CH₂—CH₂—CH₂—O—CH₂—CHOH—CH₂—N—;
and R, R′ and R″ are independently selected from at least one of hydrogen, C₁₋₁₀₀ alkyl, C₆₋₃₀ aryl, C₇₋₃₀ aralkyl; C₇₋₃₀ alkaryl; C₁₋₃₀ hydroxyalkyl; C₃₋₂₀₀ polyhydroxyalkyl; polyether consisting of from 2-200 identical or different C-₁₋₁₅ oxyalkylene units, wherein, if there is present more than one type of oxyalkylene unit, there shall be present at least two of each unit; C₁₋₃₀ aminoalkyl; polyiminopolyalkylene having from 1-20 identical or different C₂₋₁₅ alkylene units; polyiminopolyoxyalkylene having from 1-20 identical or different C₂₋₁₅ oxyalkylene units; C₃₋₃₀ quaternary ammonium, optionally completely or partially ionised with at least one anion; C₄₋₃₀ betaine; carboxyl, optionally completely or partially ionised with at least one cation; C₄₋₃₀ polycarboxyalkyl, optionally completely or partially ionised with at least one cation; sulpho group, optionally completely or partially ionised with at least one cation; thiosulpho group, optionally completely or partially ionised with at least one cation; epoxide group; glycidyl; acrylate; C₁₋₃₀ ester; polyester consisting of from 2-200 C₂₋₁₅ diacid and diester monomer units; and esters of inorganic acids, wherein all alkyl chains are at least one of linear, branched or comprise at least one ring.
